(19) United States
(12) Patent Application Publication
(10) Pub. No.: US 2004/0144222 A1
(43) Pub. Date: Jul. 29, 2004

(54) Power saw attachment

(76) Inventor: Scott Wayne, Hawthorne, NY (US)

Correspondence Address: LITMAN LAW OFFICES, LTD., P.O. BOX 15035 CRYSTAL CITY STATION, ARLINGTON, VA, 22215, US

(21) Appl. No.: 10/351,542

(22) Filed: Jan. 27, 2003

(51) Int. Cl. B26D 7/01

(52) U.S. Cl. 83/13; 83/437.1

(57) ABSTRACT

A power saw attachment comprising a compound measuring guide, a cross cut measuring guide, a sliding fence, two adjustable looking pieces, a base, mounting brackets, at least one tripod stand and a portable power saw. The present invention may be used with any appropriate power saw including, but not limited to, radial arm saws and miter box chop saws. An accurate cut is made by first attaching the chop saw attachment to a saw. Next, the sliding fence is moved to the desired measurement and the sliding fence is locked into place. The desired material to be cut is then placed onto the power saw attachment with the base of the material positioned against the locked sliding fence and backstop. The material is then cut at the desired length.

### BACKGROUND OF THE INVENTION

1. Field of the Invention

The present invention relates to power saw attachments, and more particularly to a measuring guide attachment for a power saw.

2. Description of the Related Art

Power saws are commonly used by both professional carpenters and ordinary homeowner handy men. When using a power saw, it is inaccurate to measure the length of the workpiece and then mark the length with a pencil. Also, if several cuts are going to be made at the same length, it is inefficient to measure, mark and re-measure every time you make a cut. It is common to use workbenches with cutting and measuring guides that aid in making accurate cuts. These workbenches do not help when using a portable power saw because the benches themselves are not portable. Measuring guide attachments for portable power saws have been created for improving cutting accuracy.

Certain examples of measuring guide attachments that are representative of the power saw industry are disclosed in the following patents. U.S. Pat. No. 4,557,170 to Ingham discloses a workpiece saw cutoff length measuring device. The measuring device is used in combination with a miter saw, or the like, and comprises a workpiece guide rail that extends laterally from the plane of the saw and slidably supports a workpiece length measuring frame. The frame supports a conventional spring wound measuring tape case for indicating a desired dimension for cutting a workpiece to length, and includes a tape clamp for maintaining the tape in a selected extended position.

U.S. Pat. No. 5,815,931 to Cleveland discloses a cutting guide for controlling the direction and cut of a handheld power cutting tool. The cutting guide is removably attached to any one of a number of hand operated power cutting tools. The cutting guide includes a L-shaped guide plate with two sets of channels for receiving two adjustable guide arms. The first guide arm functions to guide the direction of the saw. The second guide arm extends to a point that is spaced from an end of the workpiece so as to move with the cutting tool towards the end of the workpiece to limit the length of the cutting path.

U.S. Pat. No. 6,240,822 to Musser discloses an adjustable precision indexing jig used in conjunction with power tools. The jig includes a plurality of swing arms that can be rotated onto a table and used as stops to aid in positioning of a workpiece on the device that is to be worked at a specific cut location, such as the cut length for a saw.

The problem with these measuring guide attachments is that they do not provide a sturdy, reliable means for accurately measuring a workpiece and locking the measurement into place so that multiple cuts can be made without having to re-measure the workpiece. Several of the common measuring guide attachments in existence provide a means for limiting the cutting length of a power saw. These measuring guides, however, still require the user to measure and mark the workpiece prior to each cut.

therefore, what is needed is a measuring guide attachment that may be easily attached to any common power saw. What is further needed is a measuring guide attachment that allows any user, skilled or unskilled, to make accurate and precise cuts. What is still further needed is a measuring guide attachment that provides a means for locking in the desired measurement so that the user is confident the correct length will be cut. Finally, what is needed is a measuring guide attachment that will increase cutting productivity by allowing the user to make multiple cuts at the same length without having to re-measure and mark after each cut is made.

None of the above inventions and patents, taken either singularly or in combination, is seen to describe the instant invention as claimed. Thus a power saw attachment solving the aforementioned problems is desired.

### SUMMARY OF THE INVENTION

The present invention is a power saw attachment meeting some or all of the industry needs mentioned above. The present invention allows any user to accurately cut any material. Preferred embodiments of the present invention comprise an angle measuring guide, a cross cut measuring guide, a sliding fence, adjustable looking pieces, a base, mounting brackets, at least one tripod stand, a back stop and a portable power saw. In certain preferred embodiments of the present invention, the power saw attachment is used with a conventional chop saw. The present invention is not limited to being used with a conventional chop saw and may be used with any appropriate power saw including, but not limited to, radial arm saws and miter box chop saws.

According to one aspect of the present invention mounting brackets are used to releasably attach the base of the power saw attachment to the saw. The sliding fence allows the user to “lock-in” a desired cut length. This allows the user to make multiple cuts without having to re-measure and mark the workpiece before each cut. The tripod stands are attached under the base to provide support to the power saw attachment. The tripod stands increase the safety of the work environment by providing stability to the power saw while cutting. The adjustable looking pieces allow the user to view the measuring guide to accurately position the sliding fence at the desired measurement. The adjustable looking pieces are preferably made of glass but may be made from any appropriate, transparent material.

According to preferred embodiments of the present invention, two separate measuring guides are provided on the base of the power saw attachment. A cross cut measuring guide is located on the bottom of the base. The cross cut measuring guide is used for most common cuts, including straight cuts and cuts made at 45° and 90° angles. A compound measuring guide is located on the top of the base. The compound measuring guide is used for compound cuts that are made at angles other than 45° and 90°.

According to a method aspect of the present invention an accurate cut is made by first attaching the chop saw attachment to a saw. Next, the sliding fence is moved to the desired measurement and the sliding fence is locked into place. The workpiece is then placed onto the power saw attachment with the base of the material positioned against the locked sliding fence and the backstop. The material is then cut at the desired length. The present invention increases productivity and efficiency while decreasing waste by providing a means for accurately cutting material without having to re-measure and mark the material.

Accordingly, it is a principal object of the invention to provide a measuring guide attachment that may be easily attached to any common power saw.

It is another object of the invention to provide a measuring, guide attachment that allows any user, skilled or unskilled, to make accurate and precise cuts.

It is a further object of the invention to provide a measuring guide attachment that provides a means for locking in the desired measurement so that the user is confident the correct length will be cut.

Still another object of the invention is to provide a measuring guide attachment that will increase cutting productivity by allowing the user to make multiple cuts at the same length without having to re-measure and mark after each cut is made.

It is an object of the invention to provide improved elements and arrangements thereof for the purposes described which is inexpensive, dependable and fully effective in accomplishing its intended purposes.

These and other objects of the present invention will become readily apparent upon further review of the following specification and drawings.

### BRIEF DESCRIPTION OF THE DRAWINGS

FIG. 1 is a fragmented environmental, perspective view of a power saw attachment according to the present invention.

FIG. 2 is a fragmented perspective view of the power saw attachment depicted in FIG. 1.

FIG. 3 is a fragmented side view of the power saw attachment depicted in FIG. 1.

FIG. 4 is a cross sectional view of the base of the power saw attachment.

Similar reference characters denote corresponding features consistently throughout the attached drawings.

### DETAILED DESCRIPTION OF THE PREFERRED EMBODIMENTS

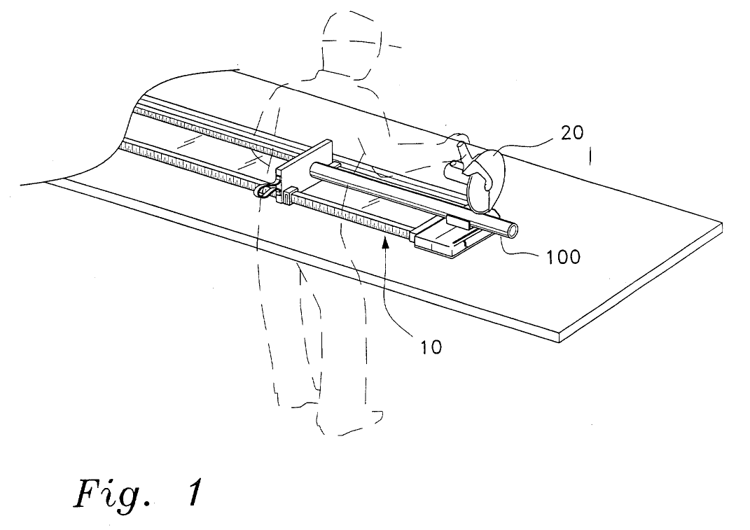

The present invention is a measuring attachment for power saws. The present invention improves cutting precision and productivity by providing the user with a means for accurately cutting material without having to measure, mark and re-measure the material. FIG. 1 depicts an environmental view of a user cutting a workpiece 100 with a power saw 20 equipped with the power saw attachment 10.

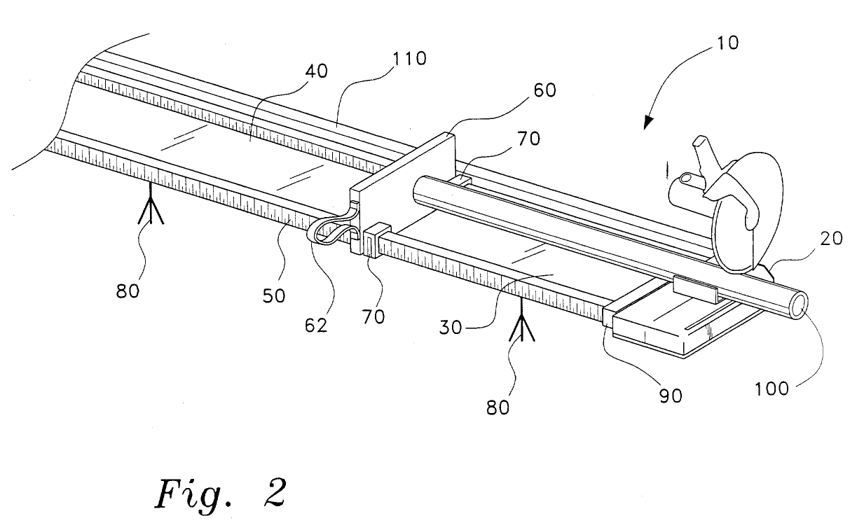

FIG. 2 depicts a perspective view of the power saw attachment 10 attached to a conventional chop saw 20. In the present embodiment the power saw attachment 10 is adapted to attach to a chop saw 20 but is not limited to being attached to chop saws. The power saw attachment 10 may be attached to any appropriate power saw, either portable or stationary, including but not limited to chop saws, radial arm saws and miter box chop saws. The base 30 of the power saw attachment 10 is secured to the chop saw 30 using a mounting bracket 90. The mounting bracket 90 comprises a pair of bolts for securing the mounting bracket 90 and a quick release mechanism for releasing the mounting bracket 90. The mounting bracket 90 can be any suitable, inexpensive, quick releasing fastening mechanism known to those skilled in the art.

The power saw attachment 10 comprises a base 30, an angle measuring guide 40, a cross cut measuring guide 50, a sliding fence 60, adjustable looking pieces 70, a backstop 110 and at least one tripod stand 80. In the preferred embodiments the length of the power saw attachment 10 is in the range of eight feet to twelve feet, but it is not limited to these dimensions. The power saw attachment 10 can be made twelve feet in length, or a four foot extension can be mounted to an existing eight foot power saw attachment 10.

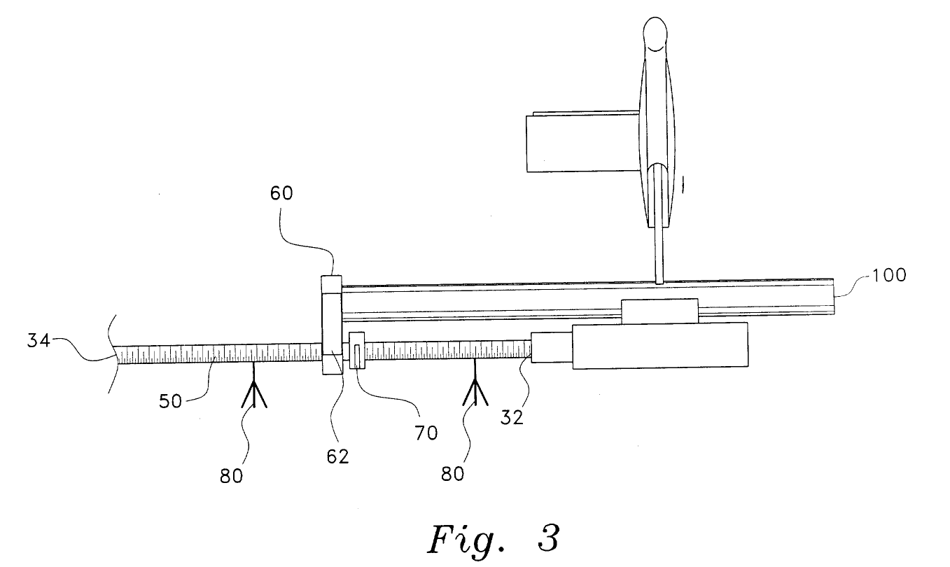

FIG. 3 depicts a side view of the power saw attachment 10. The base 30 of the power saw attachment 10, in certain preferred embodiments, has a width in the range of 4.5 inches to six inches, but the base 30 is not limited to these dimensions. The base 30 has a first end 32 and a second end 34. The chop saw attachment 10 is secured to the power saw 20 by attaching the first end 32 of the base 30 to the power saw 20 with the mounting bracket 90. The base 30 may be precasted out of aluminum or hollow tubing aluminum, but is not limited to being made from these materials.

The sliding fence 60 slidably moves along the length of the top portion of the base 30 from the first end 32 to the second end 34. Once the sliding fence 60 is positioned at the desired measurement it is releasably locked into position. The sliding fence is locked into position by pressing down on a handle until the sliding fence 60 is locked into place. Once the sliding fence 60 is secured in its locked position the power saw attachment 10 prevents the power saw 20 from cutting past the desired measurement. The cross cut measuring guide is used for most common cuts, including straight cuts and cuts made at 45° and 90° angles. The compound measuring guide is used for compound cuts that are made at angles other than 45° and 90°.

The compound measuring guide 40 and the cross cut measuring guide are provided to determine the desired measurement on the material to be cut. The compound measuring guide 40 and the cross cut measuring guide are essentially rulers that allow the user to measure the workpiece to determine the appropriate location of the desired measurement. The backstop 110 is located behind the compound measuring guide 40 and extends three inches above the top of the compound measuring guide 40. The backstop 110 prevents the workpiece from moving off of the power saw attachment 10 while a cut is being made.

The adjustable looking pieces 70 are provided so the user can accurately lock the sliding fence 60 into the desired measurement. The adjustable looking pieces 70 are slidably repositioned along the length of the base 30. Once the adjustable looking pieces 70 are in the desired position it is releasably locked into place. In certain preferred embodiments of the present invention the adjustable looking pieces 70 are made from glass. The adjustable looking pieces 70 are not limited to being made from glass and may be made from any appropriate, transparent material.

At least one tripod stand 80 is provided for support of the power saw attachment 10. In the preferred embodiment depicted in FIG. 2 there are two tripod stands 80 provided but in other embodiments only one tripod may be used. The number of tripod stands 80 that are used is determined by the length of the chop saw attachment 10 that is used. The tripod stands 80 are secured to the bottom of the base 30. In preferred embodiments the tripods stands 80 have a height in the range of three to six inches, but these dimensions do not limit them. The tripod stands 80 may be extended to the user's desired height.

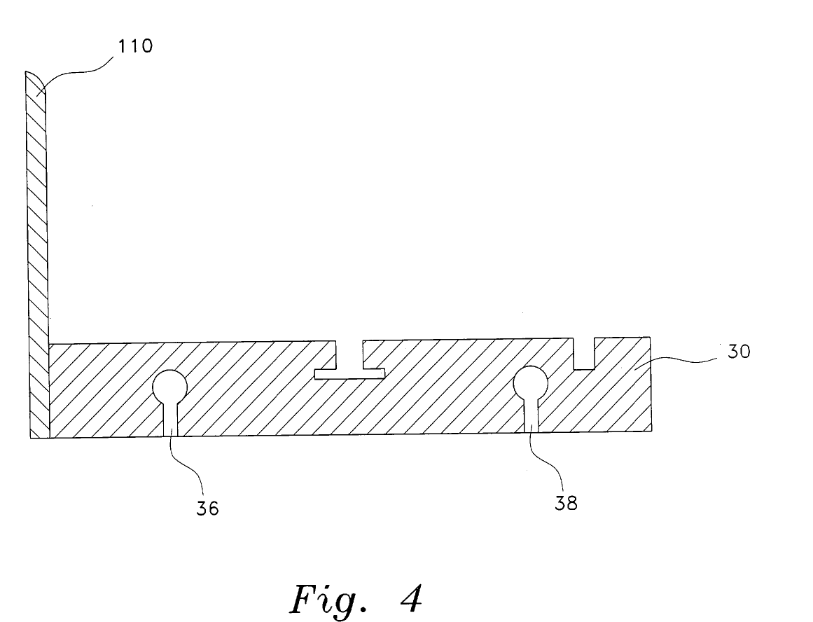

FIG. 4 depicts a cross sectional view of the base 30 of the power saw attachment 10. There are two slots 36 and 38 that are adapted to receive the two bolts of the mounting bracket 90. The two slots 36 and 38 allow the mounting bracket to releasably attach the base 30 of the power saw attachment 10 to the power saw 20. The bolts of the mounting bracket 90 slide into the slots 36 and 38 and releasably lock into place, securing the base 30 to the mounting bracket 90. The quick release mounting bracket 90 allows the base 30 of the power saw attachment 10 to be attached to and released from the power saw 20 with little effort or time.

To use the present invention the power saw attachment 10 must first be secured to the power saw 20 by releasably attaching the base 30 to the power saw 20 using a mounting bracket 90. The workpiece 100 is then measured. The sliding fence 60 is then moved to the desired measurement on the cross cut measuring guide 50 and releasably locked into place. The sliding fence 60 is locked into place by pulling down on a fence handle 62 until the sliding fence is secured onto the cross cut measuring guide 50. The workpiece 100 is then placed on the power saw attachment 10 with the base of the workpiece 100 positioned against the sliding fence 60. The sliding fence 60, in its releasably locked position, holds the workpiece 100 in place. The user may then cut the workpiece 100. Using the power saw attachment 10 the user may make multiple cuts of the material without having to re-measure and mark the material before each cut. The workpiece 100 is accurately cut because the measurement is locked into place by the sliding fence 60 on the cross Cut measuring guide 50.

It is to be understood that the present invention is not limited to the embodiments described above, but encompasses any and all embodiments within the scope of the following claims.

I claim:

1. A power saw attachment comprising:
a base;
a backstop;
a compound measuring guide attached to said base;
a cross cut measuring guide attached to said base;
a sliding fence attached to said base;
a plurality of adjustable looking pieces attached to said fence; and
at least one tripod stand disposed below said base.

2. The power saw attachment according to claim 1, wherein said base is dimensioned and configured for attachment to a power saw.

3. The power saw attachment according to claim 1, wherein said base is dimensioned and configured for attachment to a power saw using at least one mounting bracket.

4. The power saw attachment according to claim 1, wherein said compound measuring guide is located along a top portion of said base.

5. The power saw attachment according to claim 1, wherein said sliding fence is slidably repositionable along the length of said measuring guide.

6. The power saw attachment according to claim 1, wherein said sliding fence is capable of being releasably locked into position to secure a desired measurement on said cross cut measuring guide.

7. The power saw attachment according to claim 1, wherein said crosscut measuring guide is located on a bottom portion of said base.

8. The power saw attachment according to claim 1, wherein said adjustable looking pieces move slidably along the length of the base while attached to said sliding fence.

9. The power saw attachment according to claim 1, wherein said adjustable looking piece is a transparent material.

10. The power saw attachment according to claim 1, wherein said adjustable looking piece is glass.

11. The power saw attachment according to claim 1, wherein said at least one tripod stand supports said base.

12. The power saw attachment according to claim 1, wherein said at least one tripod stand is attached to the bottom of said base.

13. The power saw attachment according to claim 1, wherein said backstop is located behind said compound measuring guide and extends above said compound measuring guide to prevent said workpiece from moving off of said power saw attachment.

14. A method for accurately cutting material using a power saw attachment, comprising the steps of:
moving sliding fence to desired measurement on said cross cut measuring guide;
releasably locking sliding fence into position;
placing said material onto said power saw attachment with the base of said material positioned against said sliding fence and a backstop; and
cutting said material.
